(19) United States
(12) Patent Application Publication
(10) Pub. No.: US 2019/0300778 A1
(43) Pub. Date: Oct. 3, 2019

(54) ENHANCING PROPPANT PACK DISTRIBUTION IN PROPPED FRACTURES

(71) Applicant: Halliburton Energy Services, Inc., Houston, TX (US)

(72) Inventors: Philip D. NGUYEN, Houston, TX (US); Walter T. STEPHENS, Houston, TX (US)

(21) Appl. No.: 16/335,612

(22) PCT Filed: Nov. 2, 2016
(86) PCT No.: PCT/US2016/060057

§ 371 Date: Mar. 21, 2019

(51) Int. Cl. C09K 8/66; C09K 8/80; E21B 43/267

(52) U.S. Cl. CPC C09K 8/665; E21B 43/267; C09K 8/805

(57) ABSTRACT

The embodiments of the present disclosure provide for enhanced production of subterranean formations (i.e., wellbores in such formations) for the recovery of hydrocarbons, for example. The embodiments utilize various sizes and concentrations of proppant (e.g., sand proppant, micro-proppant, and/or macro-sand proppant) in created or enhanced fractures or fracture networks in subterranean formations penetrated by a wellbore using a plurality of fluid stages. As used herein and with reference the embodiments here described, the wellbore may be vertical, horizontal, or deviated (neither vertical, nor horizontal), without departing from the scope of the present disclosure.

### BACKGROUND

The embodiments herein relate generally to subterranean formation operations and, more particularly, to enhancing proppant pack distribution in subterranean formations.

Hydrocarbon producing wells (e.g., oil producing wells, gas producing wells, and the like) are often stimulated by hydraulic fracturing treatments. In traditional hydraulic fracturing treatments, a treatment fluid, sometimes called a carrier fluid in cases where the treatment fluid carries particulates entrained therein, is pumped into a portion of a subterranean formation (which may also be referred to herein simply as a “formation”) above a fracture gradient sufficient to break down the formation and create one or more fractures therein. The term “treatment fluid,” as used herein, refers generally to any fluid that may be used in a subterranean application in conjunction with a desired function and/or for a desired purpose during a subterranean formation operation. The term “treatment fluid” does not imply any particular action by the fluid or any component thereof. As used herein, the term “fracture gradient” refers to a pressure necessary to create or enhance at least one fracture in a particular subterranean formation location (e.g., interval); increasing pressure within a formation may be achieved by placing fluid therein at a high flow rate.

Typically, particulate solids are suspended in a portion of the treatment fluid and then deposited into the fractures, where they settle therein. The particulate solids, known as “proppant particulates” or simply “proppant” serve to prevent the fractures from fully closing once the hydraulic pressure is removed. By keeping the fractures from fully closing, the proppant form a proppant pack having interstitial spaces that act as conductive paths through which fluids produced from the formation may flow. As used herein, the term “proppant pack” refers to a collection of proppant in a fracture, thereby forming a “propped fracture.” The degree of success of a stimulation operation depends, at least in part, upon the ability of the proppant pack to permit the flow of fluids through the interconnected interstitial spaces between proppant while maintaining open the fracture.

### BRIEF DESCRIPTION OF THE DRAWINGS

The following figures are included to illustrate certain aspects of the embodiments described herein, and should not be viewed as exclusive embodiments. The subject matter disclosed is capable of considerable modifications, alterations, combinations, and equivalents in form and function, as will occur to those skilled in the art and having the benefit of this disclosure.

FIG. 1A depicts the initial formation of a sand proppant pack, according to one or more embodiments of the present disclosure.

FIG. 2 depicts the process of creating or enhancing secondary branch fractures and forming a macro-sand proppant pack, according to one or more embodiments of the present disclosure.

FIG. 3 depicts an embodiment of a system configured for delivering various treatment fluids of the embodiments described herein to a downhole location, according to one or more embodiments of the present disclosure.

### DETAILED DESCRIPTION

The embodiments herein relate generally to subterranean formation operations and, more particularly, to enhancing proppant pack distribution in subterranean formations, including unconventional subterranean formations, such as shale and tight-gas formations.

The embodiments of the present disclosure provide for enhanced production of subterranean formations (i.e., wellbores in such formations) for the recovery of hydrocarbons, for example. The embodiments utilize various sizes and concentrations of proppant (e.g., sand proppant, micro-proppant, and/or macro-sand proppant) in created or enhanced fractures or fracture networks in subterranean formations penetrated by a wellbore using a plurality of fluid stages. As used herein and with reference the embodiments here described, the wellbore may be vertical, horizontal, or deviated (neither vertical, nor horizontal), without departing from the scope of the present disclosure.

The embodiments described herein involve at least the formation of a dominate fracture, and in some embodiments, additional branch fractures that connect directly or indirectly to the dominate fracture. As used herein, the term “dominate fracture,” and grammatical variants thereof, refers to a primary fracture extending from a wellbore. A “branch fracture,” and grammatical variants thereof, as used herein, refers to any fracture extending from a dominate fracture or extending from any non-dominate fracture (e.g., a secondary branch fracture, a tertiary branch fracture, and the like). That is, a secondary branch fracture is a microfracture extending from a dominate fracture. A tertiary branch fracture is a microfracture that extends from a secondary branch fracture. Branch fractures, regardless of the type of fracture from which they originate, have a flow channel width or flow opening size that is less than that of the dominate fracture or non-dominate fracture from which it extends. Typically, branch fractures, regardless of the type of fracture from which they originate, have a flow channel width or flow opening size of from about 1 μm to about 100 μm, encompassing any value and subset therebetween. The branch fractures may be cracks, slots, conduits, perforations, holes, or any other ablation within the formation. As used herein, the term “fracture” refers collectively to dominate fractures and microfractures, unless otherwise specified.

The embodiments of the present disclosure deposits a sand proppant pack at a bottom side of a dominate fracture and a macro-sand proppant pack at the top side of the same dominate fracture, where both the sand proppant pack and the macro-sand proppant pack serve to prop open the fracture. In some instances, secondary branch fractures are first created or extended from the dominate fracture prior to deposition of the macro-sand proppant pack. Accordingly, the propped dominate fractures described herein are the result of sequentially filling a dominate fracture volume from the bottom side to the top side, thereby enhancing the effective fracture height (e.g., vertical distribution of the proppant within the fracture).

Advantages of the present disclosure include not only utilization of a layered packing process to increase proppant suspension and proppant vertical distribution for enhanced opened-fracture height, but also is effective at utilizing low-quality, and thus low-cost, propping materials, such as local sand, for forming the proppant packs described herein. Accordingly, the embodiments described herein may allow for elimination or minimization of high-strength, high-cost (or at least higher-cost) proppant materials. Further advantages of the embodiments of the present disclosure include, but are not limited to the use of sand proppant particulates to ensure successful placement of propping material at an extended distance into the formation, advantageous use of settling to place a large amount of sand proppant particulates at the bottom of the dominate fracture to bear most of the fracture closure stress, enhanced development of vertical height and lateral packing in the top side of fracture of the proppant fracture, and minimization of the downward extension of the fracture height by use of the sand proppant pack at the bottom of the dominate fracture as an effective barrier (e.g., preventing fracturing into an underlying water zone).

As used herein, the term “proppant pack,” and grammatical variants thereof, collectively refers to both the sand proppant pack and the macro-sand proppant pack of the present disclosure, which differ at least by the size of the proppant material included therein. For example, low-quality sand proppant particulates may be used to form the sand proppant pack at the bottom side of the fracture, as described below, to bear a substantial portion, or in some instances, all of the closure stress load upon dissipation of hydraulic pressure from a fracture. As used herein, the term “fracture closure stress” (or simply “closure stress”), and grammatical variants thereof, refers to the stress (or pressure) at which a fracture effectively closes without proppant in place in the absence of hydraulic pressure. Such low-quality sand proppant particulates may additionally be used to form proppant aggregates for use in forming the macro-sand proppant pack described herein at the top side of the fracture, as described below. As used herein, the term “proppant aggregate” refers to a coherent body of propping material, such that the proppant aggregate does not tend to disperse into smaller bodies without the application of shear. In certain instances, such low-quality proppant material may additionally be used to form the macro-sand proppant pack if it is micro-sand sized and capable of forming interstitial spaces and withstanding adequate fracture closure stress.

Regarding the advantages of the low-quality sand or macro-sand proppant described herein, in traditional subterranean formation operations in which proppant particulates are used, the International Organization for Standardization (ISO) 13503 provides specifications for proppant particulates for use in hydraulic fracturing operations. Specifically, ISO 13503 provides fracturing proppant sizes, sphericity and roundness of proppant, acid solubility of proppant, maximum proppant turbidity, and maximum crush resistance for the material forming the proppant. (See ISO 13503-2, Amendment 1, 2006)). Accordingly, ISO 13503 provides the characteristics of proppant particulates used by the oil and gas industry for fracturing operations, and characteristics falling outside of these recommendations are generally deemed by the industry as unsatisfactory for use in such operations. Different from the recommended proppant particulates according to ISO 13503, the low-quality propping materials for forming the sand packs described herein need not meet all of the ISO 13503 characteristics, or even any of those characteristics to be used according to the embodiments herein. Accordingly, as used herein, the term “low-quality propping material” or “low-quality proppant,” and grammatical variants thereof, refers collectively to sand sized, micro-sand sized, and macro-sand sized proppant particulates failing to meet at least one of the recommended ISO 13503 characteristics. The term “low-quality propping material” or “low-quality proppant” encompasses the term “local sand,” as described below, and thus, such local sand additionally fails to meet at least one or the recommended ISO 13503 characteristics provided herein. It will be appreciated that although the embodiments described herein advantageously permit the use of low-quality propping materials (e.g., local sand), traditional sand and proppant particulates may be utilized as described herein, without departing from the scope of the present disclosure.

The various ISO 13503, as stated above, provide for proppant particulate characteristics regarding size, sphericity and roundness, acid solubility of proppant, maximum proppant turbidity, and maximum crush resistance for the material forming the proppant. For example, ISO 13503 provides the requirement that a proppant be sized within a designated coarse sieve and a designated fine sieve, where not over 0.1% of the proppant particulates are larger than the coarse sieve and not over 1.0% are smaller than the fine sieve. For fracturing proppant, a minimum of 90% of the proppant particulates must pass the coarse sieve and be retained on the fine sieve. Proppant particulates, according to ISO 13503, require an average sphericity of 0.7 or greater and an average roundness of 0.7 or greater for ceramic proppant particulates and require an average sphericity of 0.6 or greater and an average roundness of 0.6 or greater for non-ceramic proppant particulates. ISO 13503 further specifies that fracturing proppant should not exceed the generation (or produce less than) 10% of crushed material (“fines”) upon application of the highest stress level. The low-quality propping materials (e.g., local sand) of the present disclosure fails to meet at least one and up to all of such requirements.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” As used herein, the term “about” encompasses +/−5% of a numerical value. For example, if the numerical value is “about 5,” the range of 4.75 to 5.25 is encompassed. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

As used herein, the term “substantially” means largely, but not necessarily wholly.

The use of directional terms such as above, below, upper, lower, upward, downward, left, right, uphole, downhole and the like are used in relation to the illustrative embodiments as they are depicted in the figures herein, the upward direction being toward the top of the corresponding figure and the downward direction being toward the bottom of the corresponding figure, the uphole direction being toward the surface of the well and the downhole direction being toward the toe of the well. Additionally, the embodiments depicted in the figures herein are not necessarily to scale and certain features are shown in schematic form only or are exaggerated or minimized in scale in the interest of clarity.

In some embodiments, the embodiments described herein provide a method of introducing a high-viscosity treatment fluid (HVTF) comprising a base fluid into a subterranean formation at a pressure above the fracture gradient of the formation to create or extend at least one fracture therein. Thereafter, a low-viscosity sand treatment fluid (LVSTF) is introduced into the subterranean formation alternatingly with a low-viscosity solids-free treatment fluid (LVSFTF) above the fracture gradient, where the LVSTF is introduced at an injection rate that is higher than the injection rate of the LVSFTF (or, in other words, the LVSFTF is introduced at an injection rate that is lower than the injection rate of the LVSTF). The LVSFTF comprises a base fluid and no intentionally placed solid particulates. As used herein, the term “solids-free” with reference to a treatment fluid (e.g., the LVSFTF) means that no solid particulates are intentionally introduced into the fluid; it does not preclude solid particulates from entering into the fluid as it traverses through oil and gas equipment or the formation (e.g., formation fines, and the like). Generally, a solids-free treatment fluid has no more than about 5% solids by weight before it is introduced into a subterranean formation.

The LVSTF comprises a base fluid and sand proppant particulates, which may be at least partially coated with a curable consolidating agent. The concentration of the sand proppant particulates in the LVSTF is continuously increased overtime as the LVSTF is introduced into the formation. In some embodiments, the continual increase in the concentration of the sand proppant particulates in the LVSTF is performed to achieve a final (or the highest) concentration of about 1.2 grams per milliliter (g/mL), beginning generally at a concentration of equal to or greater than about 0.012 g/mL. Generally the beginning concentration is equal to or less than about 0.20 g/mL, beginning at equal to or greater than about 0.012 g/mL. For example, in an embodiment, the concentration of the sand proppant particulates in the LVSTF is continually increased from about 0.012 g/mL to about 1.2 g/mL. The continual increase may be gradual (i.e., non-stop continuous increase) or step-wise (i.e., incremental continuous increase). For example, for hydraulic fracturing of unconventional formations (e.g., shale, coal bed methane, and the like), the beginning concentration may be about 0.029 g/mL and increase by about 0.059 g/mL over time, where the ending concentration is about 0.479 g/mL or about 0.359 g/mL. In another example, for hydraulic fracturing of conventional formations (e.g., sandstone), the beginning concentration may be about 0.119 g/mL and increase gradually to a concentration of about 0.959 g/mL, or about 0.839 g/mL, or about 0.719 g/mL. The time between each increase in concentration depends at least on the desired amount of sand proppant particulates to be placed in the one or more fractures in the formation.

The sand proppant particulates are deposited on the bottom side of the at least one fracture, thereby forming a sand proppant pack at the bottom side of the at least one dominate fracture. The alternating introduction of the LVSFTF with the LVSTF can be used to sweep the sand proppant particulates into the fracture and minimize build-up of the sand proppant particulates at certain areas (e.g., “dune” formation) and mitigate potential screenout in the near wellbore region. In some instances, the volume of the LVSFTF is reduced compared to the volume of the LVSTF, as only a small volume may be needed to achieve the sweeping and minimization of screenout, as discussed above. Accordingly, the sand proppant particulates settle or are otherwise swept to the bottom of the at least one dominate fracture, thereby forming a sand proppant pack.

Various approaches may be applied to enhance the settling of the sand proppant particulates to the bottom side of the fracture including, but not limited to, use of a low-viscosity treatment fluid, reducing injection rate, use of relatively large sized sand proppant particulates (sizes are discussed below), use of high density sand proppant particulates, increased sand proppant particulate concentration during introduction thereof, at least partially coating the sand proppant particulates with a curable consolidating agent, and the like. However, as discussed below regarding the size of the sand proppant particulates, although larger sizes may be used, small sized sand proppant particulates are preferred in the embodiments of the present disclosure for use in forming the sand proppant pack in the bottom side of the at least one dominate fracture because it may be more economical and readily available, such as the local sand described herein.

When the sand proppant particulates are at least partially coated with a curable consolidating agent, one or more activating agents may be included with the LVSFTF or the LVSTF, or in a different fluid that is introduced after the sand proppant pack is formed, without departing from the scope of the present disclosure. The activating agent is used for activating the curable consolidating agent coated on the sand proppant particulates. The curable consolidating agent is cured such that the sand proppant particulates consolidate into a hardened mass or are tacky and adhere together in combination with exposure of the sand proppant pack to fracture closure stress consolidates the sand proppant pack at the bottom of the at least one dominate fracture and locks at least a substantial portion of the sand proppant particulates therein in place. In other embodiments, the fracture closure stress alone consolidates the sand proppant pack and locks at least a substantial portion of the sand proppant particulates therein in place.

In some embodiments, the alternating introduction of the LVSTF and the LVSFTF and deposition of the sand proppant particulates in the bottom side of the at least one dominate fracture is repeated at least once, or multiple times, to achieve the desired sand proppant pack density.

After the sand proppant pack is formed as previously described, a high-viscosity proppant treatment fluid (HVPTF) comprising a base fluid and either or both of macro-sand proppant particulates or proppant aggregates, as described below. The HVPTF is introduced above the fracture gradient of the subterranean formation. In some embodiments, the concentration of the macro-sand proppant particulates and/or the proppant aggregates is increased continuously overtime as the HVPTF is introduced. In some embodiments, the continual increase in the concentration of the macro-sand proppant particulates and/or proppant aggregates in the LVPTF is performed to achieve a final (or the highest) concentration of about 1.2 g/mL, beginning generally at a concentration of equal to or greater than about 0.012 g/mL. Generally the beginning concentration is equal to or less than about 0.20 g/mL, beginning at equal to or greater than about 0.012 g/mL. For example, in an embodiment, the concentration of the macro-sand proppant particulates and/or proppant aggregates in the LVPTF is continually increased from about 0.012 g/mL to about 1.2 g/mL. As described above, the continual increase may be gradual (i.e., non-stop continuous increase) or step-wise (i.e., incremental continuous increase).

The macro-sand proppant particulates and/or the proppant aggregates are deposited on the top side of the at least one fracture above the sand proppant pack, thereby forming a macro-sand proppant pack at the top side of the at least one fracture which extends the height of the dominate fracture and increases packing coverage on the top size of the at least one fracture. The macro-sand proppant pack, whether composed of macro-sand proppant particulates and/or proppant aggregates, permits the flow of produced hydrocarbons therethrough for collection at the surface. In some instances, to facilitate the formation of the macro-sand proppant pack, the macro-sand proppant particulates and/or the proppant aggregates are at least partially coated with a curable consolidating agent (like that which may be coated onto the sand proppant particulates) and the activating agent may be included in the HVPTF alone or in encapsulated form (e.g., by a wax) or otherwise included in a subsequent treatment fluid for activating the curable consolidating agent, without departing from the scope of the present disclosure.

In some instances to facilitate the conductivity of the macro-sand proppant pack, degradable particulates are included in the HVPTF to later degrade from the macro-sand proppant pack and increase the interstitial spaces between the macro-sand proppant particulates and/or the proppant aggregates. In yet other embodiments, the HVPTF is alternatingly introduced into the subterranean formation to form solids-free channels in the macro-sand proppant pack. As used herein, the term “solids-free channels,” and grammatical variants thereof, refers to a separation between one or more proppant aggregates that does not comprise solids through which produced hydrocarbons may flow. Generally, a solids-free channel has no more than about 50%, preferably less than 30%, solids by volume. Channels may be formed by dispersing the propping material around the channels, forming masses of propping material separated by linear channels, and the like, without departing from the scope of the present disclosure.

The sand proppant pack bears most, if not all, of the fracture closure stress, permitting the macro-proppant particulates and/or the proppant aggregates deposited in the top side of the dominate fracture to be exposed to a much lower stress load. Accordingly, the conductivity of the sand proppant pack in the bottom side of the dominate fracture is negligible or at least low compared to the conductivity of the macro-sand proppant pack due to such stress load disparity, thus compensating for the low conductivity of the sand proppant pack. Moreover, the use of the HVPTF allows further extension in length of the dominate fracture compared to the bottom side of the dominate fracture, as well as an increase in the height of the top side of the dominate fracture by bypassing bedding planes that often halt such length and height extension.

In some embodiments, prior to introducing the HVPTF and after the formation of the sand proppant pack, a high-viscosity solids-free treatment fluid (HVSFTF) comprising a base fluid is introduced into the subterranean formation at a pressure above the fracture gradient to extend the length and height of the at the one dominate fracture. Thereafter, a low-viscosity micro-proppant treatment fluid (LVMTF) comprising a base fluid and micro-proppant particulates is introduced into the subterranean formation at a pressure above the fracture gradient to create or extend at least one secondary branch fracture extending from the dominate fracture along the top side of the dominate fracture. Additional branch fractures, including tertiary branch fractures, may also be created or extended, without departing from the scope of the present disclosure. Moreover, the at least one secondary branch fracture may form in the near wellbore region or the far-field region of the dominate branch fracture (or anywhere therebetween), without departing from the scope of the present disclosure. The micro-proppant particulates are deposited into the at least one secondary branch fracture to prop them open. Finally, as described above, the HVPTF is introduced and the macro-sand proppant particulates and/or proppant aggregates are deposited on the top side of the dominate fracture to form the macro-sand proppant pack.

In some embodiments, the HVSFTF and the LVMTF may be introduced prior to formation of the sand proppant pack to induce and prop secondary branch fractures along the bottom side of the dominate fracture, without departing from the scope of the present disclosure.

In some embodiments, the concentration of the micro-proppant particulates is increased continuously overtime as the LVMTF is introduced. In some embodiments, the continual increase in the concentration of the micro-proppant particulates in the LVMTF is performed to achieve a final (or the highest) concentration of about 0.12 g/mL, beginning generally at a concentration of equal to or greater than about 0.0012 g/mL. In one example, the beginning concentration is equal to or less than about 0.012 g/mL, beginning at equal to or greater than about 0.0024 g/mL. In another example, the concentration of the micro-proppant particulates in the LVMTF is continually increased from about 0.006 g/mL to about 0.036 g/mL. The continual increase may be gradual (i.e., non-stop continuous increase) or step-wise (i.e., incremental continuous increase).

In some embodiments, large-sized, high-strength proppant (i.e., meeting ISO 13503 characteristics) may be introduced in a treatment fluid after formation of the macro-sand proppant pack and deposited into the mouth of the at least one dominate fracture to ensure the macro-sand proppant pack and/or the sand proppant pack remains packed.

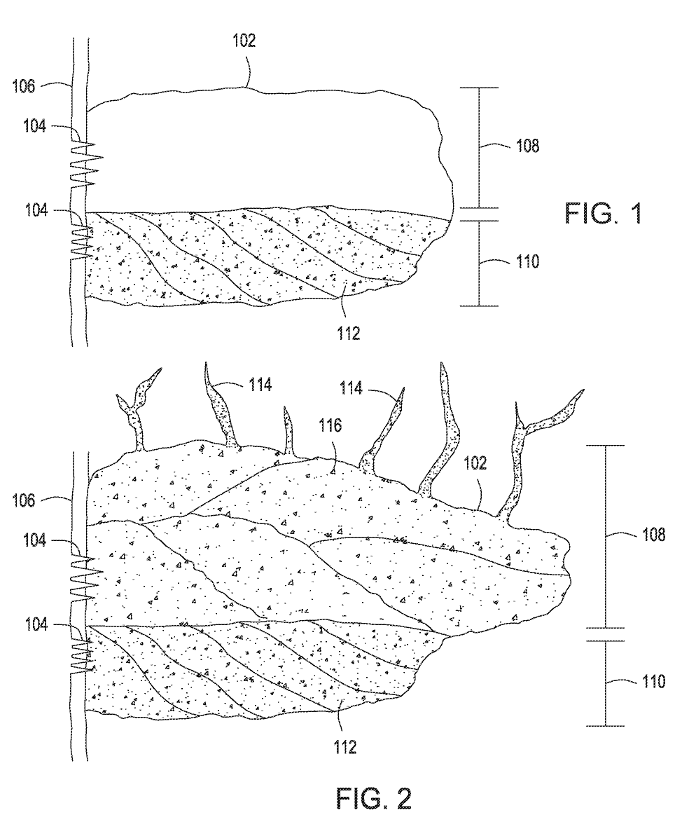

Referring now to FIG. 1, illustrated is the initial formation of a sand proppant pack, according to one or more embodiments of the present disclosure. As shown, dominate fracture 102 was formed using a HVTF described herein and introduced through perforations 104 in wellbore 106. After formation, an LVSTF is alternatingly introduced with a small volume of LVSFTF to deposit sand proppant particulates into the bottom side 110 of the dominate fracture 102 to form a sand proppant pack 112. The bottom side 110 accordingly comprises the sand proppant pack 112 and the top side 108 of the dominate fracture 102 is essentially devoid of particulates due to the settling and the “sweeping” of the sand proppant particulates, as described herein. Although not shown, as previously discussed, microfractures may have been formed prior to the formation of the sand proppant pack, without departing from the scope of the present disclosure.

Referring now to FIG. 2, with continued reference to FIG. 1 where like labels are maintained, illustrated is the process of creating or enhancing secondary branch fractures and forming a macro-sand proppant pack, according to one or more embodiments of the present disclosure. As shown, prior to introducing the macro-sand proppant particulates in the HVPTF, a HVSFTF is introduced which is used to extend the length and height of the top side 108 of the dominate fracture 102. Thereafter, a LVMTF is introduced into the dominate fracture 102 comprising micro-proppant particulates and at least one secondary branch fracture 114 (six shown) are created or enhanced and propped with the micro-proppant particulates. Thereafter, the HVPTF (which itself may enhance the length and height of the top side 108 of the dominate fracture 102) comprising macro-sand proppant particulates is introduced into the dominate fracture 102 to form a macro-sand proppant pack 116.

The plurality of treatment fluids of the present disclosure are in some instances described with reference to their viscosity, being a “high-viscosity treatment fluid” or a “low-viscosity treatment fluid.” As used herein, the term “high-viscosity treatment fluid” or “HVTF” (encompassing each treatment fluid described herein referring to high-viscosity, including the HVPTF and the HVSFTF described herein) refers to a fluid having a viscosity in the range of greater than 100 centipoise (cP) to about 20000 cP, or greater than 200 cP to about 20000 cP, encompassing any value and subset therebetween. The exact viscosity may depend on a number of factors including, but not limited to, the type of subterranean formation, the desired dimensions of the at least one fracture formed, and the like. As used herein, the term “low-viscosity treatment fluid” or “LVTF” (encompassing each treatment fluid described herein referring to low-viscosity, including the LVSFTF and the LVMTF described herein) refers to a fluid having a viscosity in the range of about 1 cP to less than 100 cP, encompassing any value and subset therebetween. The exact viscosity may depend on a number of factors including, but not limited to, the type of subterranean formation, the particular particulates and/or additives entrained therein, the concentration of the particular particulates and/or additives entrained therein, and the like.

The plurality of treatment fluids of the present disclosure each comprise a base fluid. Any suitable base fluid that is compatible with the components of the particular treatment fluid and compatible with the subterranean formation for performing the particular subterranean formation operation (e.g., hydraulic fracturing) may be used in accordance with the present disclosure. Examples of suitable base fluids for use in forming the treatment fluids (i.e., the HVTF, the LVSTF, the LVSFTF, the HVSFTF, the LVMTF, and the LVPTF) described herein include, but are not limited to, aqueous-based fluids, aqueous-miscible fluids, liquid oil-based fluids, liquid gas-based fluids, and any combination thereof. Suitable aqueous-based fluids may include, but are not limited to, fresh water, saltwater (e.g., water containing one or more salts dissolved therein), brine (e.g., saturated salt water), seawater, wastewater, produced water, and any combination thereof. Suitable aqueous-miscible fluids may include, but not be limited to, alcohols (e.g., methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, polyols, any derivative thereof, any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate), any in combination with an aqueous-based fluid, and any combination thereof. Examples of suitable liquid oil-based fluids may include, but are not limited to, liquid methane, liquid propane, and any combination thereof. Suitable liquid gas-based fluids may include, but are not limited to, liquid carbon dioxide, liquid natural gas, liquid petroleum gas, and any combination thereof. In any or all embodiments, one or more treatment fluids may have additives included in addition to the proppant described herein that are best suited to a particular base fluid and the use of the particular treatment fluid, as described above.

As previously described, the embodiments of the present disclosure permit the use of previously deemed “low-quality” propping material, thus enabling consumption (including local consumption) of a wide variety of low cost materials for use in generating a highly conductive fracture that have heretofore been dismissed for use in fracturing operations. High-quality propping material may also be used, at least as the macro-sand proppant particulates and large-sized proppant particulates for plugging the mouth of the at least one dominate fracture. The following examples of suitable proppant material (the term “proppant material” or “propping material” encompassing each of the sand proppant particulates, the micro-proppant particulates, the macro-sand proppant particulates, the large-sized proppant particulates, and the proppant aggregates described herein) may be high-quality or low-quality, depending on their particular composition and structure. For example, the mechanical strength of the same material will differ depending on whether the particular propping material is more or less porous compared to one another, which will influence crush resistance, as well. Examples of materials for use as the propping material of the present disclosure may include, but are not limited to, sand, bauxite, ceramic materials, glass materials, polymer materials (e.g., polystyrene, polyethylene, etc.), nut shell pieces, seed shell pieces, fruit pit pieces, wood, cements (e.g., Portland cements), fly ash, carbon black powder, silica, alumina, alumino-silicates, fumed carbon, carbon black, graphite, mica, titanium dioxide, barite, meta-silicate, calcium silicate, calcium carbonate, dolomite, nepheline syenite, feldspar, pumice, volcanic material, kaolin, talc, zirconia, boron, shale, clay, sandstone, mineral carbonates, mineral oxide, iron oxide, formation minerals, waste stream sources, man-made materials, low-quality manufacture materials, any of the aforementioned mixed with a resin to form cured resinous particulates, and any combination thereof.

In some embodiments, the low-quality propping material, local sand, is a preferred material for forming the sand proppant particulates and/or formation of the proppant aggregates in the presence of a binding material of the present disclosure. As used herein, the term “local sand” or “low-quality local sand” refers to locally available solid low-quality propping material (as defined above herein) that originates from surface sources, or from subsurface sources such as mine. Local sand may be preferred, as it is readily obtainable and is typically inexpensive because it is not traditionally used as proppant particulates in fracturing operations due to its “low-quality propping” characteristics, as defined herein. Examples of commercially available local sand include, but are not limited to, sand available from Adwan Chemical Industries Co. Ltd. in Saudi Arabia, and sand available from Delmon Co. Ltd. in Saudi Arabia. Other commercially available types of sand including, but not limited, to Brady Brown sand and Northern White sand types.

Table 1 below demonstrates the difference in various characteristics as measured using API RP19C of the commercially available local sand as compared to traditional ISO 13503 commercially available proppant particulates and Table 2 indicates the crush resistance as measured by API RP19C of the commercially available local sand as compared to traditional ISO 13503 commercially available proppant particulates. The traditional ISO 13503 commercially available proppant particulates are CARBOHSP high-density sintered bauxite proppant available from CARBO Ceramics Inc. in Houston, Tex. Of particular interest in Table 1 is the vast difference in roundness, sphericity, and in Table 2 of the vast difference in high psi fines generation in crush resistance testing. The sand numbers (e.g., 20/40, 16/30, 30/50, 30/60) indicate low and high sieve values based on U.S. Standard Sieve Series. The units “gm/cc” are grams per milliliter, “FTU” is the Fomazin Turbiditiy Unit. Table 2 lists the % of fines generated upon application of a particular closure stress. Where the symbol “--” is shown, the API RP19C measurement is not provided.

TABLE 1

| | | Bulk | Acid | | | |
|---|---|---|---|---|---|---|
| | Specific | Density | Solubility | Turbiditiy | | |
| Particulate Type | Gravity | (gm/cc) | (%) | (FTU) | Sphericity | Roundness |
| Adwan 20/40 sand | 2.64 | — | 3.76 | 65 | 0.64 | 0.7 |
| Delmon 20/40 sand | 2.63 | 1.53 | 0.55 | 20 | 0.72 | 0.71 |
| Northern White 20/40 sand | 2.65 | 1.53 | 0.6-0.7 | 45-70 | 0.7-0.9 | 0.7-0.9 |
| Brown 20/40 sand | 2.65 | 1.54 | 0.9 | 48 | 0.64 | 0.62 |
| Adwan 16/30 sand | — | 1.58 | 2.22 | 10 | 0.77 | 0.66 |
| Delmon 16/30 sand | — | 1.6 | 1.11 | 15 | 0.73 | 0.6 |
| Delmon 30/50 sand | — | 1.51 | 0.55 | 21 | 0.65 | 0.68 |
| CARBOHSP 30/60 proppant | 3.61 | 2.1 | 2.5 | — | 0.9 | 0.9 |

TABLE 2

| | Crush | Crush | Crush | Crush | Crush | Crush |
|---|---|---|---|---|---|---|
| | (1000 psi) | (2000 psi) | (3000 psi) | (4000 psi) | (5000 psi) | (6000 psi) |
| Adwan 20/40 sand | — | 1.3% | — | 10.5% | — | 24.5% |
| Delmon 20/40 sand | 0.3% | 1.3% | 5.4% | 17.1% | — | — |
| Northern White 20/40 sand | — | 0.7% | — | 1.6% | 2.6% | — |
| Brown 20/40 sand | — | 0.7% | 2.0% | 6.7% | — | — |
| Adwan 16/30 sand | — | 3.3% | — | 22.9% | — | 37.0% |
| Delmon 16/30 sand | — | 4.7% | — | 26.1% | — | 39.4% |
| Delmon 30/50 sand | 0.5% | 1.2% | 3.6% | 6.7% | 15.7% | — |
| CARBOHSP 30/60 proppant | — | — | — | — | — | 0.1% |

The sand proppant particulates, the micro-proppant particulates, and the macro-sand proppant particulates differ at least by size, where the sand proppant particulates are generally smaller than both the macro-sand proppant particulates and the micro-proppant particulates, and the macro-sand particulates are generally larger than both the sand proppant particulates and the micro-proppant particulates. The size is selected such that the sand proppant particulates are selected to form the sand proppant pack, where applicable the micro-proppant particulates are selected to prop branch fractures, and the macro-sand proppant particulates are selected to form the macro-sand proppant pack. In some embodiments, the sand proppant particulates have an average unit mesh size in the range of from greater than 100 micrometers (μm) to 500 (μm), encompassing any value and subset therebetween. As used herein, the term “unit mesh size” refers to a size of an object (e.g., propping material) that is able to pass through a square area having each side thereof equal to a specified numerical value. In some embodiments, the micro-proppant particulates have an average unit mesh size in the range of from about 0.1 micrometers (μm) to 100 μm, encompassing any value and subset therebetween. In some embodiments, the macro-sand proppant particulates have an average unit mesh size in the range of from greater than 500 micrometers (μm) to about 3000 (μm), encompassing any value and subset therebetween. The proppant aggregates described herein may be formed using a binding agent and any of the sand proppant particulates, including low-quality local sand, or any of the macro-sand proppant particulates. In some instances, the proppant aggregates may be the size of the macro-sand proppant particulates described herein (e.g., when composed of sand proppant particulates) or larger (e.g., when composed of macro-sand proppant particulates). In some embodiments, the proppant aggregates have an average unit mesh size in the range of from about 500 micrometers (μm) to about 100,000 (μm), encompassing any value and subset therebetween.

In some instances, it may be beneficial to employ low density macro-sand proppant particulates or proppant aggregates to facilitate their suspension at the top side of the at least one fracture to form the macro-sand proppant pack. As used herein, the terms “low density macro-sand proppant particulates” or “low density proppant aggregates” have a density that is less than about 3.6 grams per cubic centimeter (g/cm³). In some embodiments, the low density macro-sand proppant particulates or low density proppant aggregates have a density that is greater than about 1.05 g/cm³ to less than about 3.6 g/cm³, encompassing any value and subset therebetween. In other embodiments, the low density macro-sand proppant particulates or low density proppant aggregates have a density of about 1 g/cm³.

The shape of the various proppant material described herein may be of any shape capable of meeting the desired unit mesh size or unit mesh size range, as described herein. For example, the proppant may be substantially spherical, fibrous, or polygonal in shape. As used herein, the term “substantially spherical,” and grammatical variants thereof, refers to a material that has a morphology that includes spherical geometry and elliptic geometry, including oblong spheres, ovoids, ellipsoids, capsules, and the like and may have surface irregularities. As used herein, the term “fibrous,” and grammatical variants thereof, refers to fiber-shaped substances having aspect ratios of greater than about 5 to an unlimited upper limit. The term “polygonal,” and grammatical variants thereof, as used herein, refers to shapes having at least two straight sides and angles. Examples of polygonal proppant may include, but are not limited to, a cube, cone, pyramid, cylinder, rectangular prism, cuboid, triangular prism, icosahedron, dodecahedron, octahedron, pentagonal prism, hexagonal prism, hexagonal pyramid, and the like, and any combination thereof.

In some embodiments, degradable particulates may be included in any or all of the treatment fluids described herein. When included, the degradable particulates can degrade downhole, such as after their placement in a fracture, to increase the conductivity of the fracture, and the porosity of the propped fracture. The degradable particulates can also be used to create solids-free channels through which hydrocarbons can flow. Any degradable particulate suitable for use in a subterranean formation may be used in accordance with the embodiments described herein. For example, some suitable degradable particulates include, but are not limited to, degradable polymers, dehydrated salts, and any combination thereof. As for degradable polymers, a polymer is considered to be “degradable” herein if the degradation is due to, in situ, a chemical and/or radical process, such as hydrolysis or oxidation. When included, the degradable particulates may be included in a concentration of about 5% to about 300% by weight of the propping material in the particular treatment fluid, encompassing any value and subset therebetween. When included in the solids-free treatment fluids described above, such fluids may be no longer considered “solids-free” and may be particularly useful in forming solids-free channels between the various propping material described herein.

In some embodiments of the present disclosure, the sand proppant particulates are at least partially coated with a curable consolidating agent. As used herein, the term “at least partially” with reference to coating propping material refers to coating at least about 25% of the outer surface of the propping material, and up to 100%. The amount of curable consolidating agent needed to achieve the desired coating percentage may depend on a number of factors including, but not limited to, the type of curable consolidating agent selected, the type of activating agent selected, the type of propping material (or degradable particulate) used, and the like. Any of the micro-proppant particulates, the macro-sand proppant particulates, the proppant aggregates, and/or the degradable particulates may additionally be at least partially coated with a curable consolidating agent, without departing from the scope of the present disclosure.

One type of curable consolidating agent suitable for use in the methods of the embodiments of the present disclosure includes a liquid hardenable curable consolidating agent component and an activating agent, which may be included separately in a different treatment fluid, or in the same treatment fluid as the partially coated propping or degradable material, including in encapsulated form. The curable consolidating agent component comprises a hardenable resin and an optional solvent. The solvent may be added to the curable consolidating agent to reduce its viscosity for ease of handling, mixing and transferring. It is within the ability of one skilled in the art, with the benefit of this disclosure, to determine if and how much solvent may be needed to achieve a viscosity suitable to the subterranean conditions. Factors that may affect this decision include, but are not limited to, the geographic location of the well, the surrounding weather conditions, the desired long-term stability of the curable consolidating agent, and the like. An alternate way to reduce the viscosity of the curable consolidating agent is to heat it.

The curable consolidating agent is activated by an activating agent component for curing the curable consolidating agent, of which the curable consolidating agent and/or the activating agent may further comprise an optional silane coupling agent, an optional solvent, an optional surfactant, an optional hydrolyzable ester, and an optional liquid carrier fluid for, among other things, reducing the viscosity of the activating agent component.

Examples of curable consolidating agents include, but are not limited to, organic resins such as bisphenol A diglycidyl ether resins, butoxymethyl butyl glycidyl ether resins, bisphenol A-epichlorohydrin resins, bisphenol F resins, polyepoxide resins, novolak resins, polyester resins, phenol-aldehyde resins, urea-aldehyde resins, furan resins, urethane resins, glycidyl ether resins, urethane resins, other epoxide resins, and combinations thereof.

Any solvent that is compatible with the curable consolidating agent and achieves the desired viscosity effect may be suitable for use in the curable consolidating agent. Suitable solvents may include, but are not limited to, butyl lactate, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, methanol, butyl alcohol, d'limonene, fatty acid methyl esters, and butylglycidyl ether, and combinations thereof. Other preferred solvents may include, but are not limited to, aqueous dissolvable solvents such as, methanol, isopropanol, butanol, and glycol ether solvents, and combinations thereof. Suitable glycol ether solvents include, but are not limited to, diethylene glycol methyl ether, dipropylene glycol methyl ether, 2-butoxy ethanol, ethers of a C2 to C6 dihydric alkanol containing at least one C1 to C6 alkyl group, mono ethers of dihydric alkanols, methoxypropanol, butoxyethanol, and hexoxyethanol, and isomers thereof. Selection of an appropriate solvent is dependent at least on the curable consolidating agent chosen.

As described above, use of a solvent in the curable consolidating agent is optional but may be desirable to reduce the viscosity of the thereof for ease of handling, mixing, and transferring. However, it may be desirable in some embodiments to not use such a solvent for environmental or safety reasons. It is within the ability of one skilled in the art, with the benefit of this disclosure, to determine if and how much solvent is needed to achieve a suitable viscosity. In some embodiments, the amount of the solvent used in the curable consolidating agent may be in the range of about 0.1% to about 30% by weight of the curable consolidating agent, encompassing any value and subset therebetween. Optionally, the curable consolidating agent may be heated to reduce its viscosity, in place of, or in addition to, using a solvent.

Examples of the activating agents that can be used in the embodiments described herein may include, but are not limited to, cyclo-aliphatic amines, such as piperazine, derivatives of piperazine (e.g., aminoethylpiperazine) and modified piperazines; aromatic amines, such as methylene dianiline, derivatives of methylene dianiline and hydrogenated forms, and 4,4′-diaminodiphenyl sulfone; aliphatic amines, such as ethylene diamine, diethylene triamine, triethylene tetraamine, and tetraethylene pentaamine; imidazole; pyrazole; pyrazine; pyrimidine; pyridazine; 1H-indazole; purine; phthalazine; naphthyridine; quinoxaline; quinazoline; phenazine; imidazolidine; cinnoline; imidazoline; 1,3,5-triazine; thiazole; pteridine; indazole; amines; polyamines; amides; polyamides; and 2-ethyl-4-methyl imidazole; and combinations thereof. The chosen activating agent often effects the range of temperatures over which the curable consolidating agent is able to cure. By way of example, and not of limitation, in subterranean formations having a temperature of about 15.5° C. (60° F.) to about 121.1° C. (250° F.), amines and cyclo-aliphatic amines such as piperidine, triethylamine, tris(dimethylaminomethyl) phenol, and dimethylaminomethyl)phenol may be preferred. In subterranean formations having higher temperatures, 4,4′-diaminodiphenyl sulfone may be a suitable activating agent. Activating agents that comprise piperazine or a derivative of piperazine have been shown capable of curing various curable consolidating agents from temperatures as low as about 10° C. (50° F.) to as high as about 176.7° C. (350° F.).

The activating agent used may be included in a treatment fluid, such as the LVSFTF, in an amount sufficient to activate the curable consolidating agent coated on the sand proppant particulates and/or other propping material or degradable particulates described herein. In some instances, the activating agent is present in an amount of from about 0.1% to about 50% by weight of the curable consolidating agent in which it is intended to activate and cure, encompassing any value and subset therebetween.

The optional silane coupling agent may be used, among other things, to act as a mediator to help bond the curable consolidating agent to propping material or degradable particulates described herein. Examples of suitable silane coupling agents may include, but are not limited to, N-2-(aminoethyl)-3-aminopropyltrimethoxysilane, 3-glycidoxypropyltrimethoxysilane, and the like, and combination thereof. The silane coupling agent may be included in the curable consolidating agent and/or the activating agent according to the chemistry of the particular group as determined by one skilled in the art with the benefit of this disclosure. In some embodiments, the silane coupling agent used is included in the curable consolidating agent in the range of about 0.1% to about 3% by weight of the curable consolidating agent, encompassing any value and subset therebetween.

Any surfactant compatible capable of facilitating the coating of the curable consolidating agent onto propping material or degradable particulates described herein may be used in the curable consolidating agent. Such may surfactants include, but are not limited to, an alkyl phosphonate surfactant (e.g., a C12-C22 alkyl phosphonate surfactant), an ethoxylated nonyl phenol phosphate ester, one or more cationic surfactants, and one or more nonionic surfactants. Combinations of one or more cationic and nonionic surfactants also may be suitable. The surfactant or surfactants that may be used may be included in the curable consolidating agent in an amount in the range of about 1% to about 10% by weight of the curable consolidating agent, encompassing any value and subset therebetween.

While not required, examples of hydrolyzable esters that may be used in the curable consolidating agent may include, but are not limited to, a combination of dimethylglutarate, dimethyladipate, and dimethylsuccinate; dimethylthiolate; methyl salicylate; dimethyl salicylate; and dimethylsuccinate; and combinations thereof. When used, the hydrolyzable ester is included in the curable consolidating agent in an amount in the range of about 0.1% to about 3% by weight of the curable consolidating agent, encompassing any value and subset therebetween.

Use of a diluent or liquid carrier fluid in the curable consolidating agent and/or the activating agent is optional and may be used to reduce the viscosity of the curable consolidating agent and/or the activating agent for ease of handling, mixing, and transferring. For example, as previously stated, it may be desirable in some embodiments to not use such a solvent for environmental or safety reasons. Any suitable carrier fluid that is compatible with the curable consolidating agent and/or the activating agent and achieves the desired viscosity effects is suitable for use in the embodiments of the present disclosure. Some suitable liquid carrier fluids are those having high flash points (e.g., about 125° F.) because of, among other things, environmental and safety concerns. Such solvents may include, but are not limited to, butyl lactate, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, methanol, butyl alcohol, d'limonene, and fatty acid methyl esters, and combinations thereof. Other suitable liquid carrier fluids include aqueous dissolvable solvents such as, for example, methanol, isopropanol, butanol, glycol ether solvents, and combinations thereof. Suitable glycol ether liquid carrier fluids may include, but are not limited to, diethylene glycol methyl ether, dipropylene glycol methyl ether, 2-butoxy ethanol, ethers of a C2 to C6 dihydric alkanol having at least one C1 to C6 alkyl group, mono ethers of dihydric alkanols, methoxypropanol, butoxyethanol, and hexoxyethanol, and isomers thereof. Combinations of these may be suitable as well. Selection of an appropriate liquid carrier fluid is dependent on, inter alia, the curable consolidating agent selected, the activating agent selected, and the like.

Other curable consolidating agents suitable for use in the embodiments of the present disclosure are furan-based resins. Suitable furan-based resins include, but are not limited to, furfuryl alcohol resins, furfural resins, combinations of furfuryl alcohol resins and aldehydes, and a combination of furan resins and phenolic resins. Of these, furfuryl alcohol resins may be preferred. A furan-based resin may be combined with a solvent to control viscosity if desired. Suitable solvents for use in the furan-based consolidation fluids of the embodiments of the present disclosure include, but are not limited to, 2-butoxy ethanol, butyl lactate, butyl acetate, tetrahydrofurfuryl methacrylate, tetrahydrofurfuryl acrylate, esters of oxalic, maleic and succinic acids, and furfuryl acetate. Of these, 2-butoxy ethanol is preferred. In some embodiments, the furan-based resins suitable for use as the curable consolidating agent of the present disclosure may be capable of enduring temperatures well in excess of about 176.7° C. (350° F.) without degrading. In some embodiments, the furan-based resins suitable for use as the curable consolidating agent of the present disclosure are capable of enduring temperatures up to about 371.1° C. (700° F.) without degrading.

When a furan-based resin is selected as the curable consolidating agent, the activating agent selected may include, but is not limited to, organic or inorganic acids, such as, inter alia, maleic acid, fumaric acid, sodium bisulfate, hydrochloric acid, hydrofluoric acid, acetic acid, formic acid, phosphoric acid, sulfonic acid, alkyl benzene sulfonic acids such as toluene sulfonic acid and dodecyl benzene sulfonic acid (“DDBSA”), and the like, and any combination thereof.

Other curable consolidating agents suitable for use in the methods of the embodiments of the present disclosure are phenolic-based resins. Suitable phenolic-based resins may include, but are not limited to, terpolymers of phenol, phenolic formaldehyde resins, a combination of phenolic and furan resins, and the like, and any combination thereof. In some embodiments, a combination of phenolic and furan resins may be preferred. A phenolic-based resin may be combined with a solvent to control viscosity if desired. Examples of suitable solvents for use when the curable consolidating agent selected is a phenolic-based resin may include, but are not limited, to butyl acetate, butyl lactate, furfuryl acetate, 2-butoxy ethanol, and the like, and any combination thereof. Of these, 2-butoxy ethanol may be preferred in some embodiments.

Yet another curable consolidating agent material suitable for use in the methods of the embodiments of the present disclosure is a phenol/phenol formaldehyde/furfuryl alcohol resin comprising of about 5% to about 30% phenol, of about 40% to about 70% phenol formaldehyde, of about 10% to about 40% furfuryl alcohol, of about 0.1% to about 3% of a silane coupling agent, and of about 1% to about 15% of a surfactant. In the phenol/phenol formaldehyde/furfuryl alcohol resins suitable for use in the methods of the embodiments of the present disclosure, any silane coupling agent discussed above may be used, such as N-2-(aminoethyl)-3-aminopropyltrimethoxysilane, 3-glycidoxypropyltrimethoxysilane, and the like, and any combination thereof. Suitable surfactants may include any of those listed above, such as an ethoxylated nonyl phenol phosphate ester, combinations of one or more cationic surfactants, one or more nonionic surfactants and an alkyl phosphonate surfactant, and the like, and any combination thereof.

In various embodiments, systems configured for delivering the treatment fluids described herein to a downhole location are described. In various embodiments, the systems can comprise a pump fluidly coupled to a tubular, the tubular containing the treatment fluids described herein. It will be appreciated that while the system described below may be used for delivering any one of the treatment fluids described herein, each treatment fluid is delivered separately into the subterranean formation, unless otherwise indicated.

The pump may be a high pressure pump in some embodiments. As used herein, the term “high pressure pump” will refer to a pump that is capable of delivering a treatment fluid downhole at a pressure of about 1000 psi or greater. A high pressure pump may be used when it is desired to introduce the treatment fluids to a subterranean formation at or above a fracture gradient of the subterranean formation, but it may also be used in cases where fracturing is not desired. In some embodiments, the high pressure pump may be capable of fluidly conveying particulate matter, such as the particulates described in some embodiments herein, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluids to the high pressure pump. In such embodiments, the low pressure pump may “step up” the pressure of the treatment fluids before reaching the high pressure pump.

In some embodiments, the systems described herein can further comprise a mixing tank that is upstream of the pump and in which the treatment fluids are formulated. In various embodiments, the pump (e.g., a low pressure pump, a high pressure pump, or a combination thereof) may convey the treatment fluids from the mixing tank or other source of the treatment fluids to the tubular. In other embodiments, however, the treatment fluids may be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluids may be drawn into the pump, elevated to an appropriate pressure, and then introduced into the tubular for delivery downhole.

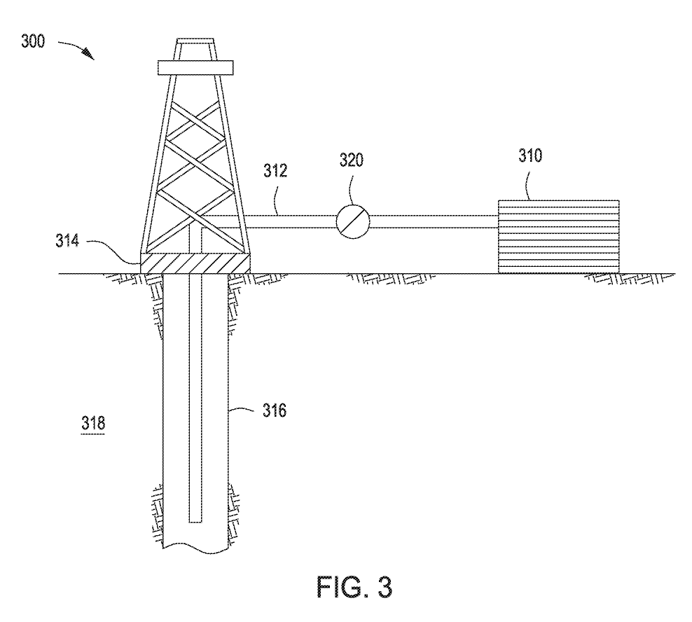

FIG. 3 shows an illustrative schematic of a system that can deliver the treatment fluids (i.e., the HVFF, the LVPadF, the LVPropF) of the present disclosure to a downhole location, according to one or more embodiments. It should be noted that while FIG. 3 generally depicts a land-based system, it is to be recognized that like systems may be operated in subsea locations as well. As depicted in FIG. 3, system 300 may include mixing tank 310, in which the treatment fluids of the embodiments herein may be formulated. The treatment fluids may be conveyed via line 312 to wellhead 314, where the treatment fluids enter tubular 316, tubular 316 extending from wellhead 314 into subterranean formation 318. Upon being ejected from tubular 316, the treatment fluids may subsequently penetrate into subterranean formation 318. Pump 320 may be configured to raise the pressure of the treatment fluids to a desired degree before introduction into tubular 316. It is to be recognized that system 300 is merely exemplary in nature and various additional components may be present that have not necessarily been depicted in FIG. 3 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 3, the treatment fluid or a portion thereof may, in some embodiments, flow back to wellhead 314 and exit subterranean formation 318. In some embodiments, the treatment fluid that has flowed back to wellhead 314 may subsequently be recovered and recirculated to subterranean formation 318, or otherwise treated for use in a subsequent subterranean operation or for use in another industry.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 3.

While various embodiments have been shown and described herein, modifications may be made by one skilled in the art without departing from the scope of the present disclosure. The embodiments described here are exemplary only, and are not intended to be limiting. Many variations, combinations, and modifications of the embodiments disclosed herein are possible and are within the scope of the disclosure. Accordingly, the scope of protection is not limited by the description set out above, but is defined by the claims which follow, that scope including all equivalents of the subject matter of the claims.

Embodiments disclosed herein include:

### Embodiment A

A method comprising: (a) introducing a high-viscosity treatment fluid (HVTF) comprising a first base fluid into a subterranean formation at a pressure above a fracture gradient of the subterranean formation to create or extend at least one dominate fracture therein; (b) alternatingly introducing a low-viscosity sand treatment fluid (LVSTF) and a low-viscosity solids-free treatment fluid (LVSFTF) into the subterranean formation at a pressure above the fracture gradient, wherein the LVSTF comprises a second base fluid and sand proppant particulates and where the concentration of the sand proppant particulates is continually increased as the LVSTF is introduced into the subterranean formation at a first injection rate, and wherein the LVSFTF comprises a third base fluid and is introduced into the subterranean formation at a second injection rate that is less than the first injection rate; (c) depositing the sand proppant particulates on a bottom side of the at least one dominate fracture by propagating movement of the sand proppant particulates in the LVSTF with the LVSFTF, thereby forming a sand proppant pack; (d) introducing a high-viscosity proppant treatment fluid (HVPTF) comprising a fourth base fluid and macro-sand proppant particulates or proppant aggregates into the subterranean formation at a pressure above the fracture gradient; and (e) depositing the macro-sand proppant particulates or the proppant aggregates on the top side of the at least one dominate fracture above the sand proppant pack, thereby forming a macro-sand proppant pack.

### Embodiment B

A method comprising: (a) introducing a high-viscosity treatment fluid (HVTF) comprising a first base fluid into a subterranean formation at a pressure above a fracture gradient of the subterranean formation to create or extend at least one dominate fracture therein; (b) alternatingly introducing a low-viscosity sand treatment fluid (LVSTF) and a low-viscosity solids-free treatment fluid (LVSFTF) into the subterranean formation at a pressure above the fracture gradient, wherein the LVSTF comprises a second base fluid and sand proppant particulates and where the concentration of the sand proppant particulates is continually increased as the LVSTF is introduced into the subterranean formation at a first injection rate, and wherein the LVSFTF comprises a third base fluid and is introduced into the subterranean formation at a second injection rate that is less than the first injection rate; (c) depositing the sand proppant particulates on a bottom side of the at least one dominate fracture by propagating movement of the sand proppant particulates in the LVSTF with the LVSFTF, thereby forming a sand proppant pack; (d) introducing a high-viscosity solids-free treatment fluid (HVSFTF) comprising a fourth base fluid into the subterranean formation at a pressure above the fracture gradient of the subterranean formation to extend the length and height of the at least one dominate fracture; (e) introducing a low-viscosity micro-proppant treatment fluid (LVMTF) comprising a fifth base fluid and micro-proppant particulates into the subterranean formation at a pressure above the fracture gradient of the subterranean formation to create or extend at least one secondary branch fracture; (f) depositing the micro-proppant particulates into the at least one secondary branch fracture, thereby propping the at least one secondary branch fracture; (g) introducing a high-viscosity proppant treatment fluid (HVPTF) comprising a fourth base fluid and macro-sand proppant particulates or proppant aggregates into the subterranean formation at a pressure above the fracture gradient; and (h) depositing the macro-sand proppant particulates or the proppant aggregates on the top side of the at least one fracture above the sand proppant pack, thereby forming a macro-sand proppant pack.

Embodiments A and B may have one or more of the following additional elements in any combination:

Element 1: Further comprising repeating (b) and (c) at least once.

Element 2: Wherein the sand proppant particulates are at least partially coated with a curable consolidating agent.

Element 3: Further comprising alternatingly introducing the LVPTF and a second LVSFTF, thereby forming solids-free channels in the macro-sand proppant pack.

Element 4: Wherein the sand proppant particulates are composed of local sand.

Element 5: Wherein the sand proppant particulates have an average unit mesh size in the range of greater than 100 micrometers to 500 micrometers.

Element 6: Wherein the concentration of sand proppant particulates in the LVSTF is continually increased from about 0.012 grams per milliliter to about 1.2 grams per milliliter.

Element 7: Wherein the macro-sand proppant particulates have an average unit mesh size in the range of greater than 500 micrometers to about 3000 micrometers.

Element 8: Wherein the proppant aggregates have an average unit mesh size in the range of about 500 micrometers to about 100,000 micrometers.

Element 8: Wherein the macro-sand proppant particulates or the proppant aggregates are low density macro-sand proppant particulates or low density proppant aggregates, and each have a density of less than about 3.6 grams per cubic centimeter; and further when included the HVTF, the HVSFTF, and the HVPTF each have a viscosity of greater than 100 centipoise (cP) to about 20000 cP, and when included the LVSTF, the LVSFTF, and the LVMTF each have a viscosity of about 1 cP to less than 100 cP.

Element 9: Further comprising a tubular extending into the subterranean formation and fluidly coupled to a pump, the tubular containing a treatment fluid selected from the group consisting of the HVTF, the LVSTF, the LVSFTF, the HVPTF, the HVSFTF, the LVMTF, and any combination thereof.

Element 10: Wherein when a LVMTF is introduced, the micro-proppant particulates have an average unit mesh size in the range of about 0.1 micrometers to 100 micrometers.

By way of non-limiting example, exemplary combinations applicable to A and B include: 1-10; 1, 3, and 8; 3, 5, 6, and 9; 8 and 10; 2, 3, and 7; 6, 8, and 10; 3 and 9; 5 and 10; 1, 4, 6, and 8; and the like; and any non-limiting combination of one, more, or all of 1-10.

Therefore, the embodiments disclosed herein are well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
(a) introducing a high-viscosity treatment fluid (HVTF) comprising a first base fluid into a subterranean formation at a pressure above a fracture gradient of the subterranean formation to create or extend at least one dominate fracture therein;
(b) alternatingly introducing a low-viscosity sand treatment fluid (LVSTF) and a low-viscosity solids-free treatment fluid (LVSFTF) into the subterranean formation at a pressure above the fracture gradient,
wherein the LVSTF comprises a second base fluid and sand proppant particulates and where the concentration of the sand proppant particulates is continually increased as the LVSTF is introduced into the subterranean formation at a first injection rate, and
wherein the LVSFTF comprises a third base fluid and is introduced into the subterranean formation at a second injection rate that is less than the first injection rate;
(c) depositing the sand proppant particulates on a bottom side of the at least one dominate fracture by propagating movement of the sand proppant particulates in the LVSTF with the LVSFTF, thereby forming a sand proppant pack;
(d) introducing a high-viscosity proppant treatment fluid (HVPTF) comprising a fourth base fluid and macro-sand proppant particulates or proppant aggregates into the subterranean formation at a pressure above the fracture gradient; and
(e) depositing the macro-sand proppant particulates or the proppant aggregates on the top side of the at least one dominate fracture above the sand proppant pack, thereby forming a macro-sand proppant pack.

2. The method of claim 1, further comprising repeating (b) and (c) at least once.

3. The method of claim 1, wherein the sand proppant particulates are at least partially coated with a curable consolidating agent.

4. The method of claim 1, wherein the sand proppant particulates are composed of local sand.

5. The method of claim 1, wherein the sand proppant particulates have an average unit mesh size in the range of greater than 100 micrometers to 500 micrometers.

6. The method of claim 1, wherein the concentration of sand proppant particulates in the LVSTF is continually increased from about 0.012 grams per milliliter to about 1.2 grams per milliliter.

7. The method of claim 1, wherein the macro-sand proppant particulates have an average unit mesh size in the range of greater than 500 micrometers to about 3000 micrometers.

8. The method of claim 1, wherein the proppant aggregates have an average unit mesh size in the range of about 500 micrometers to about 100,000 micrometers.

9. The method of claim 1, wherein the macro-sand proppant particulates or the proppant aggregates are low density macro-sand proppant particulates or low density proppant aggregates, and each have a density of less than about 3.6 grams per cubic centimeter; and further wherein the HVTF and the HVPTF each have a viscosity of greater than 100 centipoise (cP) to about 20000 cP, and the LVSTF and the LVSFTF each have a viscosity of about 1 cP to less than 100 cP.

10. The method of claim 1, further comprising a tubular extending into the subterranean formation and fluidly coupled to a pump, the tubular containing a treatment fluids selected from the group consisting of the HVTF, the LVSTF, the LVSFTF, the HVPTF, and any combination thereof.

11. A method comprising:
(a) introducing a high-viscosity treatment fluid (HVTF) comprising a first base fluid into a subterranean formation at a pressure above a fracture gradient of the subterranean formation to create or extend at least one dominate fracture therein;
(b) alternatingly introducing a low-viscosity sand treatment fluid (LVSTF) and a low-viscosity solids-free treatment fluid (LVSFTF) into the subterranean formation at a pressure above the fracture gradient,
wherein the LVSTF comprises a second base fluid and sand proppant particulates and where the concentration of the sand proppant particulates is continually increased as the LVSTF is introduced into the subterranean formation at a first injection rate, and
wherein the LVSFTF comprises a third base fluid and is introduced into the subterranean formation at a second injection rate that is less than the first injection rate;
(c) depositing the sand proppant particulates on a bottom side of the at least one dominate fracture by propagating movement of the sand proppant particulates in the LVSTF with the LVSFTF, thereby forming a sand proppant pack;
(d) introducing a high-viscosity solids-free treatment fluid (HVSFTF) comprising a fourth base fluid into the subterranean formation at a pressure above the fracture gradient of the subterranean formation to extend the length and height of the at least one dominate fracture;
(e) introducing a low-viscosity micro-proppant treatment fluid (LVMTF) comprising a fifth base fluid and micro-proppant particulates into the subterranean formation at a pressure above the fracture gradient of the subterranean formation to create or extend at least one secondary branch fracture;
(f) depositing the micro-proppant particulates into the at least one secondary branch fracture, thereby propping the at least one secondary branch fracture;
(g) introducing a high-viscosity proppant treatment fluid (HVPTF) comprising a fourth base fluid and macro-sand proppant particulates or proppant aggregates into the subterranean formation at a pressure above the fracture gradient; and
(h) depositing the macro-sand proppant particulates or the proppant aggregates on the top side of the at least one fracture above the sand proppant pack, thereby forming a macro-sand proppant pack.

12. The method of claim 11, further comprising repeating (b) and (c) at least once.

13. The method of claim 11, further comprising alternatingly introducing the LVPTF and a second LVSFTF, thereby forming solids-free channels in the macro-sand proppant pack.

14. The method of claim 11, wherein the sand proppant particulates are composed of local sand.

15. The method of claim 11, wherein the sand proppant particulates have an average unit mesh size in the range of greater than 100 micrometers to 500 micrometers.

16. The method of claim 11, wherein the concentration of sand proppant particulates in the LVSTF is continually increased from about 0.012 grams per milliliter to about 1.2 grams per milliliter.

17. The method of claim 11, wherein the micro-proppant particulates have an average unit mesh size in the range of about 0.1 micrometers to 100 micrometers.

18. The method of claim 11, wherein the macro-sand proppant particulates have an average unit mesh size in the range of greater than 500 micrometers to about 3000 micrometers.

19. The method of claim 11, wherein the proppant aggregates have an average unit mesh size in the range of about 500 micrometers to about 100,000 micrometers.

20. The method of claim 11, wherein the macro-sand proppant particulates or the proppant aggregates are low density macro-sand proppant particulates or low density proppant aggregates, and each have a density of less than about 3.6 grams per cubic centimeter; and further wherein the HVTF, the HVSFTF, and the HVPTF each have a viscosity of greater than 100 centipoise (cP) to about 20000 cP, and the LVSTF, the LVSFTF, and the LVMTF each have a viscosity of about 1 cP to less than 100 cP.
